(19) United States
(12) Patent Application Publication
(10) Pub. No.: US 2011/0227870 A1
(43) Pub. Date: Sep. 22, 2011

(54) TOUCH SCREEN SYSTEM AND METHOD FOR OBTAINING COORDINATE THEREOF

(76) Inventor: Seungkyu KIM, Hwaseong-si (KR)

(21) Appl. No.: 13/051,164

(22) Filed: Mar. 18, 2011

(30) Foreign Application Priority Data
Mar. 22, 2010 (KR) 10-2010-0025439

(51) Int. Cl. G06F 3/045

(52) U.S. Cl. 345/174

(57) ABSTRACT

A method for obtaining a coordinate of a touch screen system, the method includes generating an interrupt according to a change in a resistance value between an upper resistance layer and a lower resistance layer of a touch screen panel, obtaining coordinate information of a point corresponding to the changed resistance value between the upper and lower resistance layers, the coordinate information being obtained in response to the interrupt, determining the changed resistance value by using the obtained coordinate information, and determining validity of the obtained coordinate information according to the determined changed resistance value.

### CROSS-REFERENCE TO RELATED APPLICATIONS

This U.S. non-provisional patent application claims priority under 35 U.S.C. §119 of Korean Patent Application No. 10-2010-0025439, filed on Mar. 22, 2010, the entire contents of which are hereby incorporated by reference.

### BACKGROUND

1. Field

The present disclosure herein relates to a touch screen system and a method for obtaining a coordinate of the same.

2. Description of the Related Art

A touch screen is a kind of a screen designed for performing a command or for moving a cursor position by sensing positions, i.e., locations on the screen, contacted by a user's finger or a touch pen. The touch screen is capable of substituting input devices, e.g., a mouse and/or a keyboard, and therefore, is applied to various fields, e.g., providing tourist information and/or traffic conditions. Since an extra input device, e.g., a keyboard, is not required and an interface with a user is easy, the touch screen is widely used.

For example, touch screen technology may be classified into three types. According to a resistive method, a coordinate of a touched position may be determined based on a resistance value which varies according to pressure applied by a finger or a pen to the touched position. According to a Surface Acoustic Wave (SAW) method, the coordinate may be determined based on a change of an ultrasonic wave applied to the touch screen at the touched position. According to a capacitive method, the coordinate may be determined based on a capacitance value which varies at the touch position, e.g., circuits located at each corner of the touch screen measure the change in capacitance resulting from a finger touching a charge-storage material coated on the touch screen to determine the coordinate of the contact point. For example, unlike the resistive touch screen panel or the SAW touch screen panel, for which a user may use a finger or a pen, the capacitive touch screen panel may require direct contact by a finger.

### SUMMARY

Embodiments of the inventive concept provide methods for obtaining a coordinate of a touch screen system. The method may include generating an interrupt according to a change in a resistance value between an upper resistance layer and a lower resistance layer of a touch screen panel, obtaining coordinate information of a point corresponding to the changed resistance value between the upper and lower resistance layers, the coordinate information being obtained in response to the interrupt, determining the changed resistance value by using the obtained coordinate information, and determining validity of the obtained coordinate information according to the determined changed resistance value.

In some embodiments, generating the interrupt may include generating an interrupt according to a change in a lowest resistance value between the upper resistance layer and the lower resistance layer.

In other embodiments, generating the interrupt may include generating a down interrupt when the resistance value between the upper resistance layer and the lower resistance layer decreases and reaches an interrupt resistance value.

In still other embodiments, determining validity of the obtained coordinate information may include validating the obtained coordinate information when the determined resistance value is smaller than a first critical resistance value.

In even other embodiments, the first critical resistance value may be smaller than the interrupt resistance value.

The method may further include generating a time interrupt in the case that the detected resistance value is smaller than a first critical resistance value, obtaining the coordinate information of the point which corresponds to the variable resistance value between the upper resistance layer and the lower resistance layer in response to the time interrupt, detecting the variable resistance value by using the obtained coordinate information, and confirming or disregarding the obtained coordinate information according to the detected resistance value may be included.

In further embodiments, the time interrupt may be periodically generated in response to the down interrupt.

In still further embodiments, the generating of the time interrupt may be stopped when the minimum resistance value increases and reaches the interrupt resistance value.

In even further embodiments, the obtained coordinate information may be confirmed when the detected resistance value is smaller than a first critical resistance value in the case that the down interrupt is generated; and the obtained coordinate information may be confirmed when the detected resistance value is smaller than a second critical resistance value in the case that the time interrupt is generated.

In yet further embodiments, the second critical resistance value may be smaller than the interrupt resistance value.

In much further embodiments, the second critical resistance value may be larger than or equal to the first critical resistance value.

In still much further embodiments, the second critical resistance value may be smaller than the interrupt resistance value and larger than or equal to the first critical resistance value.

In other embodiments of the inventive concept, a method for obtaining a coordinate of a touch screen system may include determining a change of pressure applied to a touch screen panel, obtaining coordinate information of a point on the touch screen panel corresponding to the changed pressure, determining validity of the obtained coordinate information by comparing a changed resistance value on the touch screen panel with a predetermined reference value, the changed resistance value being calculated in accordance with the applied pressure and location of the point on the touch screen panel.

In other embodiments of the inventive concept, touch screen systems include a touch screen panel which may include an upper resistance layer, a lower resistance layer and an insulation layer provided between the upper resistance layer and the lower resistance layer, wherein the insulation layer includes a resistance value variable according to a distance between the upper resistance layer and the lower resistance layer; and a touch panel controller configured to generate an interrupt according to the variable resistance value, obtain coordinate information of a point which corresponds to the variable resistance value in response to the interrupt, detect the variable resistance value by using the obtained coordinate information, and confirm the obtained coordinate information in the case that the detected resistance value is smaller than a first critical resistance value.

In some embodiments, the touch panel controller includes a central processing unit configured to activate a first control signal in response to the generated interrupt; a touch driver configured to activate a second control signal in response to the activated first control signal; and a touch panel interface configured to generate the interrupt according to the variable resistance value, and obtain the coordinate information of the point which corresponds to the variable resistance value in response to the activated second control signal, wherein the touch driver detects the variable resistance value by using the obtained coordinate information, confirms the obtained coordinate information in the case that the detected resistance value is smaller than the first critical resistance value and transfers the obtained coordinate information to the central processing unit.

In other embodiments, the touch panel interface may generate a down interrupt when the variable resistance value decreases and reaches an interrupt resistance value.

In still other embodiments, the touch panel controller may further include a timer configured to generate a time interrupt in response to the down interrupt.

In even other embodiments, the touch panel controller may obtain the coordinate information of the point which corresponds to the variable resistance value in response to the time interrupt, detect the variable resistance value by using the obtained coordinate information, and confirm the obtained coordinate information in the case that the detected resistance value is smaller than a second critical resistance value.

In yet other embodiments, the central processing unit may activate a third control signal in response to the time interrupt; the touch driver may activate a fourth control signal in response to the activated third control signal; the touch panel interface may obtain the coordinate information of the point which corresponds to the variable resistance value in response to the activated fourth control signal; and the touch driver may detect the variable resistance value by using the obtained coordinate information, confirm the obtained coordinate information in the case that the detected resistance value is smaller than a second critical resistance value and transfer the obtained coordinate information to the central processing unit.

In further embodiments, the second critical resistance value may be smaller than the interrupt resistance value and larger than or equal to the first critical resistance value.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a block diagram of a touch screen system according to an embodiment of the inventive concept;

FIG. 2 illustrates a cross-sectional view of a touch screen panel when the touch screen panel is touched;

FIG. 3 illustrates a circuit diagram of an equivalent circuit of the touch screen panel illustrated in FIG. 2;

FIG. 4 illustrates a diagram of a variance of the resistance value of the variable resistor according to the pressure applied to the touch screen panel illustrated in FIG. 2;

FIG. 5 illustrates a flow chart of a method for obtaining coordinates of a touch screen system according to an embodiment of the inventive concept;

FIG. 6 illustrates a block diagram of a touch panel interface and a touch screen panel illustrated in FIG. 1;

FIG. 7 illustrates a block diagram of a standby state of the touch panel interface and the touch screen panel illustrated in FIG. 6;

FIG. 8 illustrates a block diagram of a state of the touch panel interface and the touch screen panel when the x-coordinate is obtained;

FIG. 9 illustrates a block diagram of a state of the touch panel interface and the touch screen panel when a value of first impedance Z1 is measured;

FIG. 10 illustrates a block diagram of a state of the touch panel interface and the touch screen panel when a value of second impedance Z2 is measured;

FIG. 11 illustrates a flow chart of a method for obtaining coordinates of a touch driver according to an embodiment of the inventive concept;

FIG. 12 illustrates a block diagram of a touch screen system according to another embodiment of the inventive concept;

FIG. 13 illustrates a flow chart of a method for obtaining coordinates of a touch screen system according to another embodiment of the inventive concept; and

FIG. 14 illustrates a graph of the value of the variable resistor which changes according to time.

### DETAILED DESCRIPTION

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

In the drawing figures, the dimensions of layers and regions may be exaggerated for clarity of illustration. It will also be understood that when an element is referred to as being “on” another element or substrate, it can be directly on the other element or substrate, or intervening elements may also be present. In addition, it will also be understood that when an element is referred to as being “between” two elements, it can be the only element between the two elements, or one or more intervening elements may also be present. Like reference numerals refer to like elements throughout.

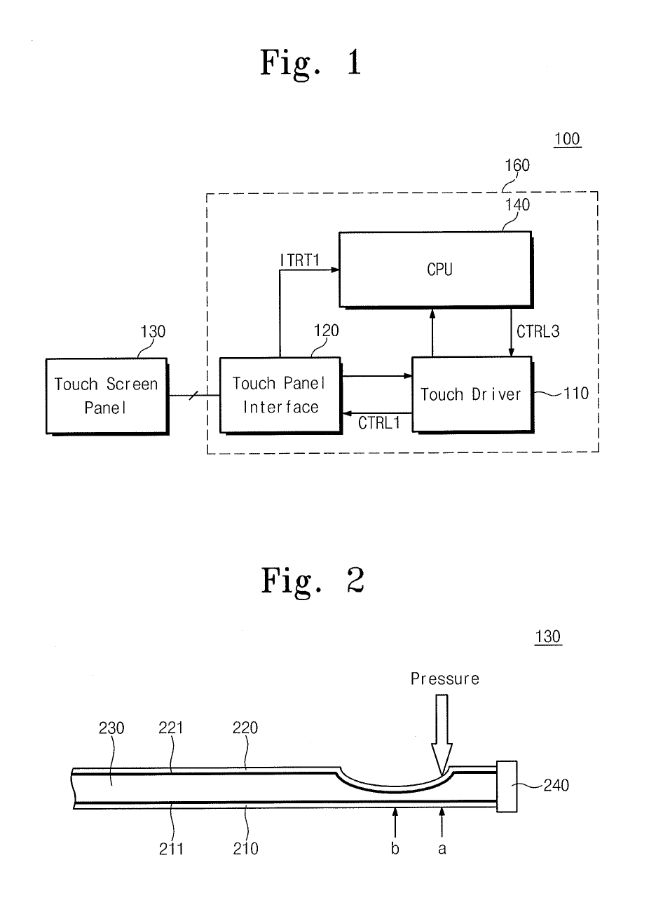

FIG. 1 illustrates a block diagram of a touch screen system 100 according to an embodiment of the inventive concept. Referring to FIG. 1, the touch screen system 100 may include a touch driver 110, a touch panel interface 120, a touch screen panel 130, and a Central Processing Unit (CPU) 140.

The touch driver 110 may be connected to the touch panel interface 120 and the CPU 140. The touch driver 110 is operated in response to control of the CPU 140. For example, in response to a third control signal CTRL3 provided by the CPU 140, the touch driver 110 transfers a first control signal CTRL1 to the touch panel interface 120.

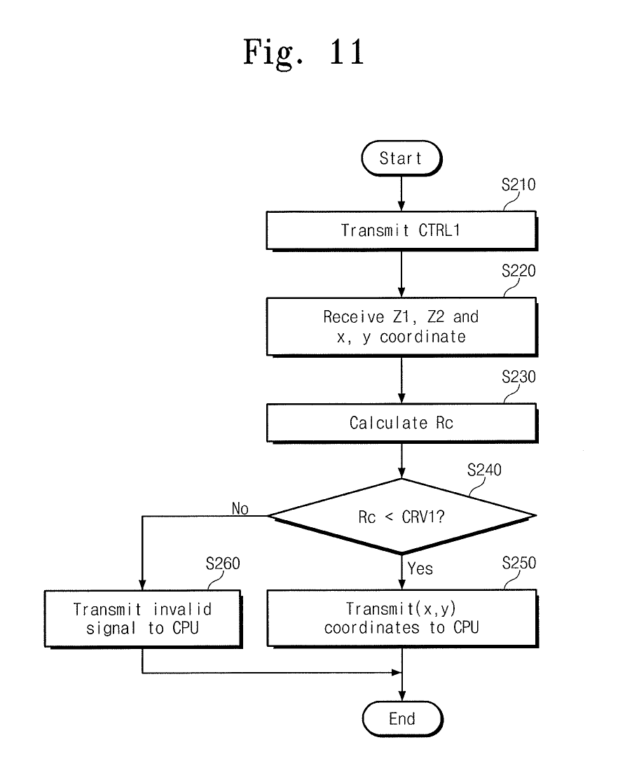

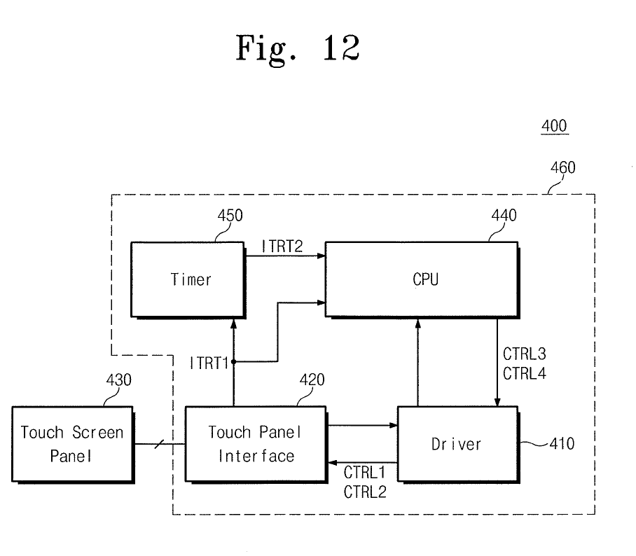

The touch driver 110 receives coordinate information of a touched point from the touch panel interface 120. The touch driver 110 may determine whether to transfer the coordinate information from the touch panel interface 120 to the CPU 140. This operation will be explained in detail referring to FIG. 11.

The touch driver 110 may be structured as hardware or software. For instance, the touch driver 110 may be the software or firmware driven at the touch panel interface 120 or the CPU 140.

The touch panel interface 120 may be electrically connected to the touch driver 110, the touch screen panel 130, and the CPU 140. The touch panel interface 120 detects pressure applied to the touch screen panel 130. For instance, the touch panel interface 120 may detect the pressure applied to the touch screen panel 130 by monitoring a resistance value of the touch screen panel 130. Based on the pressure applied to the touch screen panel 130, the touch panel interface 120 generates a touch interrupt ITRT1. The generated touch interrupt ITRT1 is transferred to the CPU 140.

For instance, in the case that the pressure applied to the touch screen panel 130 is larger than a preset pressure, the touch panel interface 120 generates a down interrupt (not shown) to the CPU 140. In another instance, if the pressure applied to the touch screen panel 130 increases and reaches the preset pressure, the touch panel interface 120 generates the down interrupt. In other words, when a user touches the touch screen panel 130, i.e., a relative increase in pressure, the touch panel interface 120 generates the down interrupt.

In yet another instance, if the pressure applied to the touch screen panel 130 decreases and reaches the preset pressure, the touch panel interface 120 generates an up interrupt. In other words, when the user stops touching the touch screen panel 130, i.e., a relative decrease in pressure, the touch panel interface 120 generates the up interrupt. The touch screen panel 130 is connected to the touch panel interface 120. The touch screen panel 130 is structured for detecting the pressure applied by the user's touch. For instance, the touch screen panel 130 includes a resistance value which is varied according to the pressure applied by the user's touch.

The touch panel interface 120 obtains the coordinate information of the touched point on the touch screen panel 130 in response to the first control signal CTRL1 received from the touch driver 110. The obtained x-coordinate and y-coordinate are transferred from the touch panel interface 120 to the touch driver 110.

The CPU 140 may be connected to the touch driver 110 and the touch panel interface 120. The CPU 140 is structured for receiving the touch interrupt ITRT1 from the touch panel interface 120. Based on the received touch interrupt ITRT1, i.e., a signal indicating a change of pressure applied to the screen, the CPU 140 generates the third control signal CTRL3. The generated third control signal CTRL3 is transferred to the touch driver 110, i.e., to trigger receipt of the touch coordinates when the screen is touched.

The touch driver 110, the touch panel interface 120, and the CPU 140 may be included in a touch panel controller 160.

FIG. 2 illustrates a cross-sectional view of the touch screen panel 130 when the touch screen panel 130 is touched. Referring to FIG. 2, the touch screen panel 130 may include a lower touch panel 210, an upper touch panel 220, an insulation layer 230, and a support 240. A lower resistance layer 211 and an upper resistance layer 221 may be respectively provided on an upper surface of the lower touch panel 210 and on a lower surface of the upper touch panel 220.

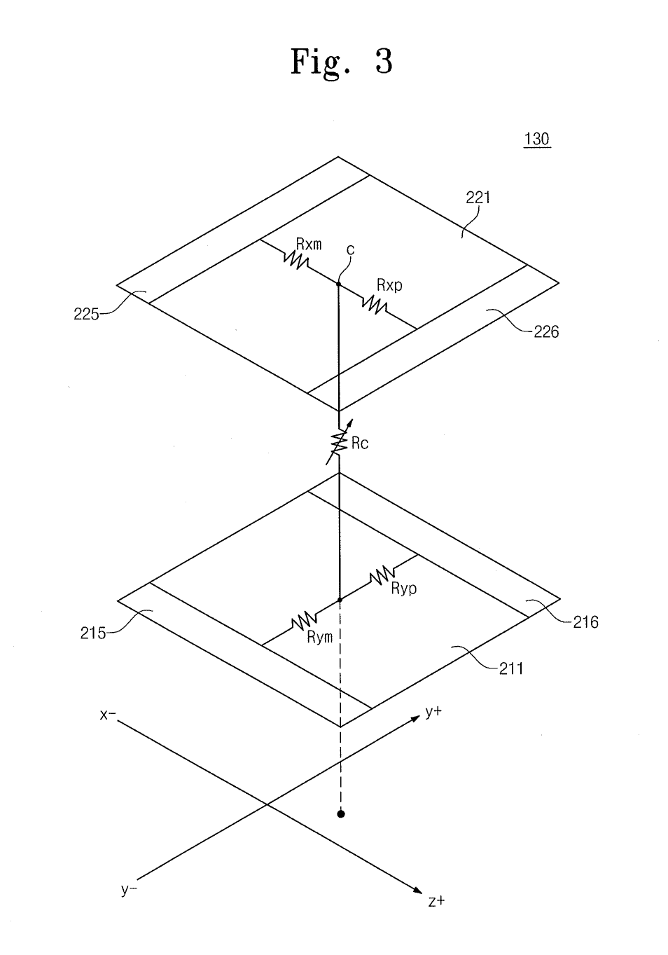

If the upper touch panel 220 is touched, i.e., if pressure is applied to the upper touch panel 220, a distance between the lower resistance layer 211 and the upper resistance layer 221 is decreased, i.e., due to the applied pressure. Based on the variation in distance between the lower resistance layer 211 and the upper resistance layer 221, i.e., due to applies pressure, the coordinate of the touched point may be measured. This operation will be explained in detail referring to FIG. 3.

FIG. 3 illustrates a circuit diagram of an equivalent circuit of the touch screen panel 130 illustrated in FIG. 2. Referring to FIGS. 2 and 3, the touch screen panel 130 may include the insulation layer 230, the lower resistance layer 211, and the upper resistance layer 221. The insulation layer 230 may be positioned between the lower resistance layer 211 and the upper resistance layer 221. A first x-coordinate electrode 225 and a second x-coordinate electrode 226 may be provided at both ends, i.e., opposite ends, of the upper resistance layer 221. A first y-coordinate electrode 215 and a second y-coordinate electrode 216 may be provided to the both ends, i.e., opposite ends, of the lower resistance layer 211. The first and second x-coordinate electrodes 225 and 226 provided to the upper resistance layer 221 may extend in a direction substantially orthogonal to a direction of the first and second y-coordinate electrodes 215 and 216 provided to the lower resistance layer 211.

The upper resistance layer 221 corresponds to a first resistor and a second resistor Rxm and Rxp, and the lower resistance layer 211 corresponds to a third resistor and a fourth resistor Rym and Ryp. The insulation layer 230 between the upper resistance layer 221 and the lower resistance layer 211 corresponds to a variable resistor Rc.

In detail, when a point (c) on the touch screen panel 130 is touched, a resistance between the point (c) and the first x-coordinate electrode 225 may be expressed as the first resistor Rxm, and a resistance between the point (c) and the second x-coordinate electrode 226 may be expressed as the second resistor Rxp. At the lower resistance layer 211, a resistance between the point (c) and the first y-coordinate electrode 215 may be expressed as the third resistor Rym, and a resistance between the point (c) and the second y-coordinate electrode 216 may be expressed as the fourth resistor Ryp.

The variable resistor Rc may represent the lowest resistance value among resistance values between the upper resistance layer 221 and the lower resistance layer 211. That is, at a portion to which the pressure of the touch screen panel 130 is not applied, i.e., at a portion of the touch screen panel 130 not touched by a user, the resistance value between the upper resistance layer 221 and the lower resistance layer 211 is almost infinite due to the insulation layer 230. At a pressured portion, e.g., at the touch point (c), the resistance value between the upper resistance layer 221 and the lower resistance layer 211 may have a value in accordance with the pressure applied to point (c), e.g., may be the resistance value of the variable resistor Rc.

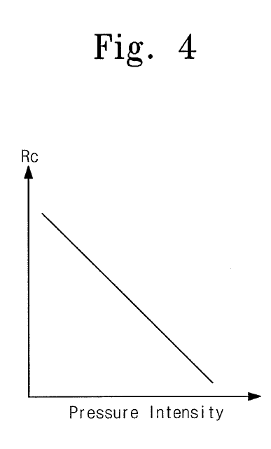

FIG. 4 is a diagram of a variance of the resistance value of the variable resistor Rc according to the pressure applied to the touch screen panel 130 illustrated in FIG. 2. Referring to FIG. 4, a horizontal axis represents pressure intensity and a vertical axis represents the resistance value of the variable resistor Rc.

Referring to FIGS. 3 and 4, since the insulation layer 230 is provided between the upper resistance layer 221 and the lower resistance layer 211, the shorter a distance between the upper resistance layer 221 and the lower resistance layer 211 is, the smaller the value of the variable resistor Rc between the upper resistance layer 221 and the lower resistance layer 211 is. In other words, a decrease in a distance between the upper resistance layer 221 and the lower resistance layer 211 may reduce the value of the variable resistor Rc. Therefore, when the pressure applied to the touch screen panel 130 becomes larger, e.g., when a user touches the touch screen panel and reduces the distance between the upper and lower resistance layers 221 and 211, the value of the variable resistance Rc becomes smaller.

For instance, in the case that the lower resistance layer 211 and the upper resistance layer 221 are in a parallel state, i.e., parallel to each other, the value of the variable resistor Rc is close to infinity. In the case that the upper resistance layer 221 is strongly touched, i.e., when strong pressure is applied to the upper resistance layer 221, so that the lower resistance layer 211 deforms to contact the upper resistance layer 221, the value of the variable resistor Rc decreases, e.g., close to about 0. That is, it may be understood that among regions between the upper resistance layer 221 and the lower resistance layer 211, a region not corresponding to the touched point (c) is in an open state and the variable resistor Rc is provided to a region corresponding to the touched point (c).

Referring to FIG. 3 again, a resistance value of the first resistor Rxm is proportional to a distance between the point (c) and the first x-coordinate electrode 225. A resistance value of the second resistor Rxp is proportional to a distance between the point (c) and the second x-coordinate electrode 226. A resistance value of the third resistor Rym is proportional to a distance between the point (c) and the first y-coordinate electrode 215. A resistance value of the fourth resistor Ryp is proportional to a distance between the point (c) and the second y-coordinate electrode 216. Accordingly, the x-coordinate of the point (c) may be determined based on the ratio of the first resistor Rxm to the second resistor Rxp, and the y-coordinate of the point (c) may be determined based on the ratio of the third resistor Rym to the fourth resistor Ryp.

For instance, the x-coordinate and y-coordinate of the point (c) may be determined by the touch panel interface 120 (refer to FIG. 1). That is, the x-coordinate of a point where the variable resistor Rc is connected to the upper resistance layer 221 and the y-coordinate of a point where the variable resistor Rc is connected to the lower resistance layer 211 may be obtained by the touch panel interface 120.

However, according to a surface state or a touched position of the touch screen panel 130, wrong x-coordinate and y-coordinate may be obtained by a conventional touch panel interface. For example, referring to FIG. 2, when a user touches point (a), i.e., when a user applies pressure to point (a), the conventional touch panel interface should obtain x-coordinate and y-coordinate of point (a). However, due to effect of the support 240, a shortest distance between the upper resistance layer 221 and the lower resistance layer 211 may be at point (b) instead of point (a), thereby causing the conventional touch panel interface to obtain wrong x-coordinate and y-coordinate, i.e., coordinates of point (b) instead of coordinates of point (a). Therefore, according to example embodiments, the touch screen system 100 may include the touch panel interface 120 that is configured to determine whether the coordinate obtained based on the resistance value of the touch screen panel 130 after the generation of the touch interrupt ITRI1 is valid.

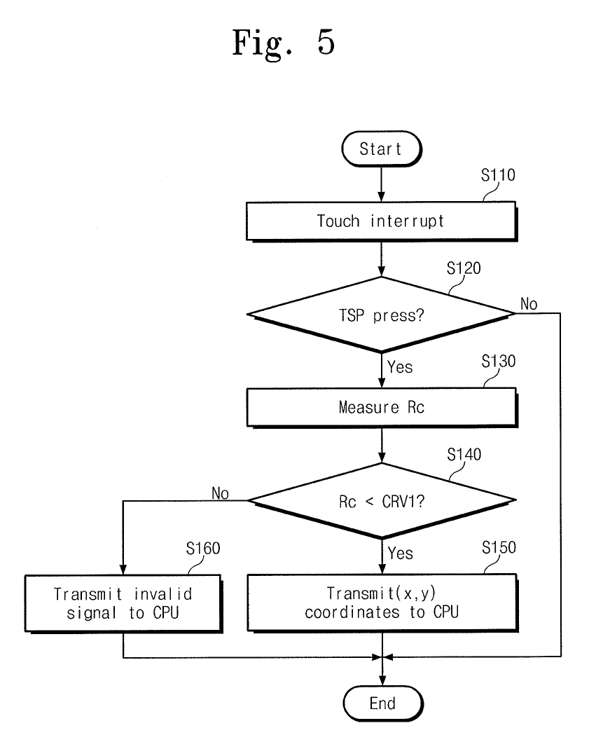

FIG. 5 illustrates a flow chart of a method for obtaining valid coordinates of the touch screen system 100 according to the embodiment of the inventive concept.

Referring to FIGS. 1, 3, and 5, in operation S110, a touch interrupt ITRT1 is transmitted from the touch panel interface 120 to the CPU 140 in response to a change in pressure applied to the touch screen panel 130. In detail, when pressure applied to the touch screen panel 130 changes, e.g., when the touch screen panel 130 is touched, the touch panel interface 120 generates the touch interrupt ITRT1. For example, when a user touches the touch screen panel 130, pressure applied to the touch screen panel 130 increases and the variable resistor Rc between the upper resistance layer 221 and the lower resistance layer 211 decreases, e.g., the value of the variable resistor Rc decreases to reach a preset resistance value (hereinafter, referred to as an interrupt resistance value), thereby triggering generation of the down interrupt. In another example, after the down interrupt is generated, if the value of the variable resistor Rc increases and reaches the interrupt resistance value, i.e., when the user releases the pressure and removes the finger/object from the touch screen panel 130, the up interrupt is generated. That is, the touch interrupt ITRT1 includes the down interrupt and the up interrupt. The touch interrupt ITRT1 generated at the touch panel interface 120 is transferred to the CPU 140.

In operation S120, the CPU 140 determines whether the received touch interrupt ITRT1 is the down interrupt or the up interrupt, i.e., whether the touch interrupt ITRT1 is generated in response to touching or releasing the touch screen panel (TSP). In the case that the received touch interrupt ITRT1 is the up interrupt, i.e., when the user removes the finger/object from the touch screen panel 130, the CPU 140 controls the touch screen system 100 for the coordinate not to be obtained. That is, in the case that the user completes an input of the coordinate to the touch screen panel 130, the coordinate is not obtained. In the case that the received touch interrupt ITRT1 is the down interrupt, i.e., a touch interrupt ITRT1 generated in response to touching the touch screen panel 130, operation S130 is performed.

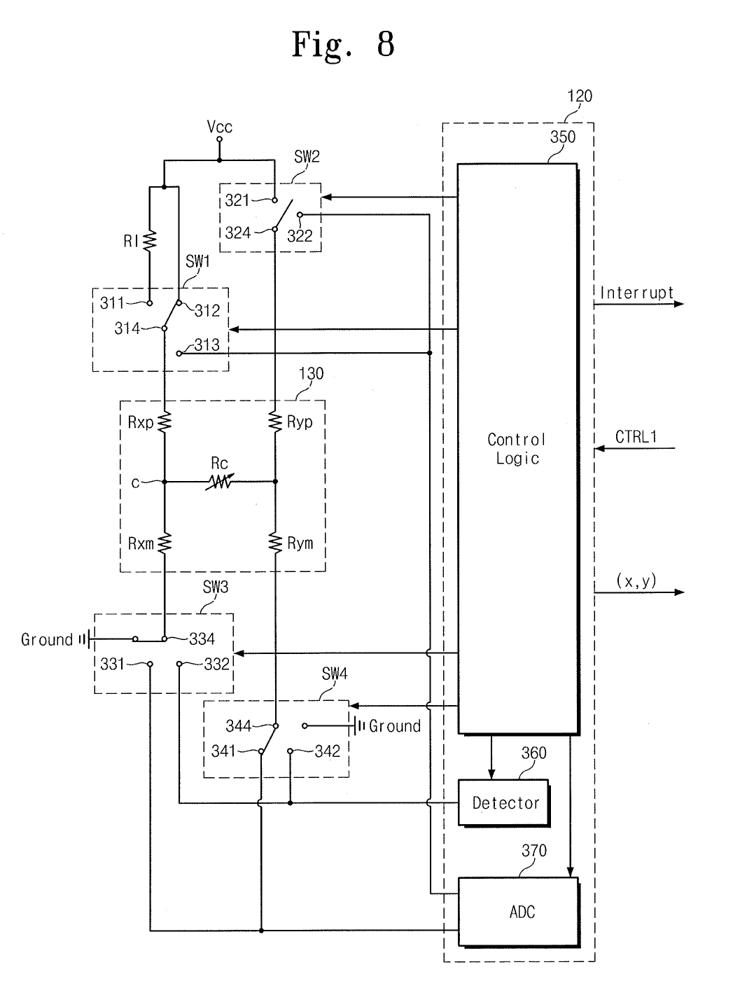

In operation S130, the value of the variable resistor Rc is measured. Once touch of the touch screen panel 130 is determined in operation S120, the CPU 140, which receives the down interrupt, transfers the third control signal CTRL3 to the touch driver 110 (FIG. 1). The touch driver 110 transfers the first control signal CTRL1 to the touch panel interface 120 in response to the third control signal CTRL3, so the touch panel interface 120 may obtain the coordinate information of the touched point on the touch screen panel 130 in response to the first control signal CTRL1. Once the touch panel interface 120 obtains the coordinate information, the touch panel interface 120 transfers the obtained coordinate information to the touch driver 110. The touch driver 110 may calculate the value of the variable resistor Rc by using the transferred coordinate information. This operation will be explained in detail referring to FIGS. 7 to 10.

In operation S140, the touch driver 110 may determine whether the calculated value of the variable resistor Rc is smaller than a first critical resistance value CRV1. The first critical resistance value CRV1 is a preset value. In the case that the calculated value of the variable resistor Rc is larger than the first critical resistance value CRV1, the touch driver 110 invalidates the coordinate information received from the touch panel interface 120. In the case that the calculated value of the variable resistor Rc is smaller than the first critical resistance value CRV1, the touch driver 110 determines that the received x-coordinate and y-coordinate are valid.

In operation S150, in the case that the received coordinate information is determined as valid, the touch driver 110 may transfer the received coordinate information to the CPU 140. In the case that the received x-coordinate and y-coordinate are determined as invalid, the touch driver 110 may transfer an invalidation signal, i.e., a signal indicating that the coordinate information is invalid, to the CPU 140 (operation S160). That is, in the case that the invalidation signal is transferred to the CPU 140, the CPU 140 controls the touch screen system 100 in order not to perform subsequent operations, i.e., to avoid performing subsequent operations with respect to the invalid coordinate information.

When the coordinate information is determined as valid and is transferred to the CPU 140, i.e., operation S150, the CPU 140 may control the touch screen system 100 by using the received coordinate information. For instance, the CPU 140 may transfer the received coordinate information to a display driver (not shown). The display driver may display a predetermined picture or image on a region of a screen which corresponds to the received coordinate information.

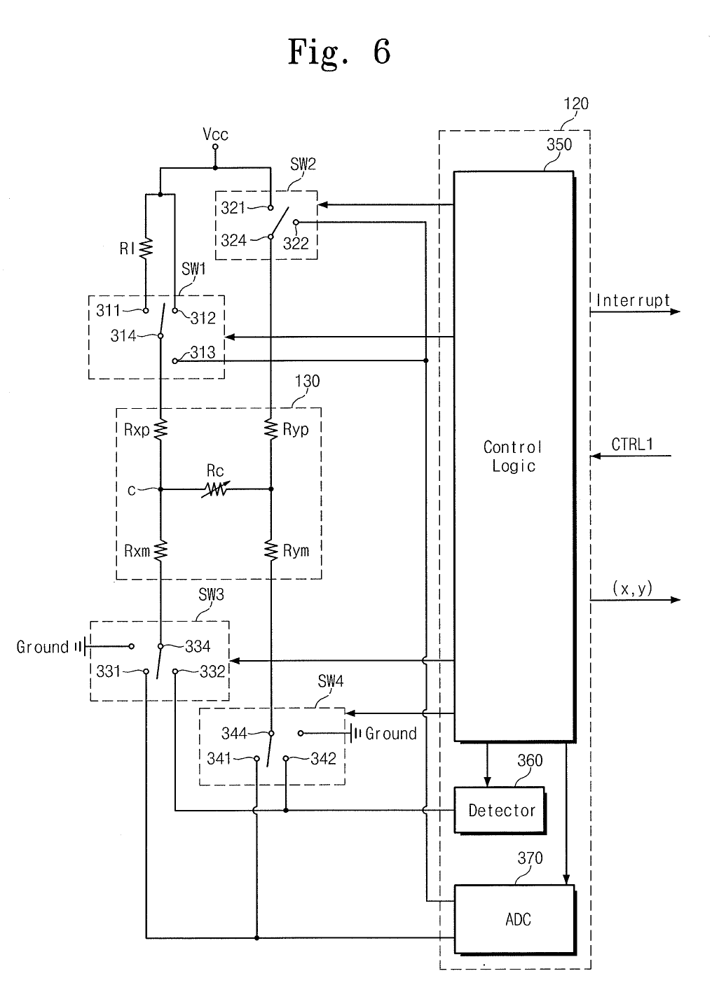

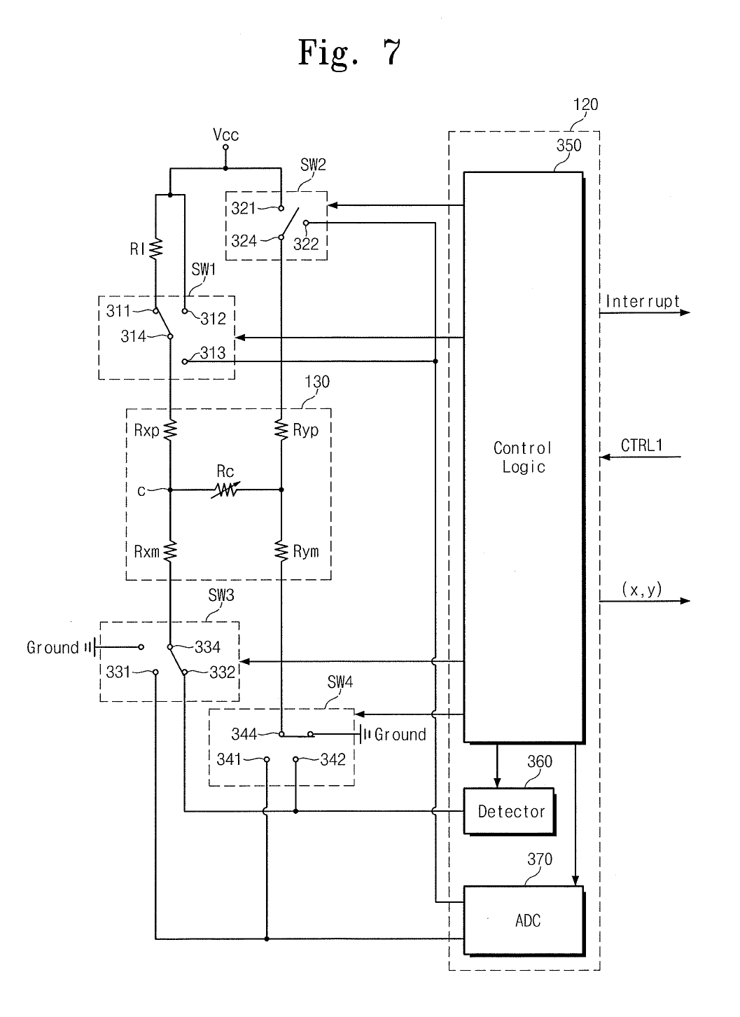

FIG. 6 illustrates a block diagram of the touch panel interface 120 and the touch screen panel 130 illustrated in FIG. 1. As illustrated in FIG. 6, the touch panel interface 120 may include a control logic 350, a detector 360, and an Analog to Digital (AD) converter 370. The control logic 350 controls the detector 360, the AD converter 370, and first to fourth switches SW1 to SW4.

The first switch SW1 connects a terminal 314 to a terminal 311, a terminal 312, or a terminal 313 in response to control of the control logic 350. The second switch SW2 connects a terminal 324 to a terminal 321 or a terminal 322 in response to the control of the control logic 350. The third switch SW3 connects a terminal 334 to a terminal 331, a terminal 332, or a ground terminal in response to the control of the control logic 350. The fourth switch SW4 connects a terminal 344 to a terminal 341, a terminal 342, or the ground terminal in response to the control of the control logic 350.

As further illustrated in FIG. 6 and as discussed previously, the touch screen panel 130 may include the variable resistor Rc, the first resistor Rxm, the second resistor Rxp, the third resistor Rym, and the fourth resistor Ryp. The first and second resistors Rxm and Rxp correspond to the upper resistance layer 221. The third and fourth resistors Rym and Ryp correspond to the lower resistance layer 211.

At the upper resistance layer 221 (refer to FIG. 2), a resistor between the touched point (c) and the terminal 334 corresponds to the first resistor Rxm, and a resistor between the touched point (c) and the terminal 314 corresponds to the second resistor Rxp. At the lower resistance layer 211, a resistor between a point corresponding to the touched point (c) and the terminal 344 corresponds to the third resistor Rym, and a resistor between the point corresponding to the touched point (c) and the terminal 324 corresponds to the fourth resistor Ryp. As described above with reference to FIGS. 2 and 3, the variable resistor Rc is provided between the upper resistance layer 221 and the lower resistance layer 211 at a region corresponding to the touched point (c).

FIG. 7 illustrates a block diagram of a standby state of the touch panel interface 120 and the touch screen panel 130. It is noted that during the standby state, the system 100 determines whether the touch interrupt ITRT1 is an up interrupt or a down interrupt, i.e., whether pressure is applied to or removed from the touch screen panel 130.

During the standby state, as illustrated in FIG. 7, the first switch SW1 connects the terminals 314 and 311. Accordingly, a power supply voltage Vcc is connected in series to the terminal 314 through a comparison resistor R1. At the second switch SW2, the terminal 324 is not connected to any of the terminals 321 and 322, i.e., the terminal 324 is in an open state. The third switch SW3 connects the terminals 334 and 332, so the terminal 334 of the touch screen panel 130 is connected to the detector 360 of the touch panel interface 120. The fourth switch SW4 connects the terminal 344 to the ground terminal, so a ground voltage is applied to the terminal 344.

It is assumed that input impedance of the detector 360 is infinite. Accordingly, a power supply terminal, the comparison resistor R1, the second resistor Rxp, the variable resistor Rc, the third resistor Rym, and the ground terminal are connected in series. The detector 360 measures a voltage of a node, i.e., the touched point (c), between the second resistor Rxp and the variable resistor Rc. The voltage measured by the detector 360 corresponds to a ratio of the variable resistor Rc and the third resistor Rym to the comparison resistor R1, the second resistor Rxp, the variable resistor Rc, and the third resistor Rym. For instance, the node voltage measured by the detector 360 is expressed as Equation (1).

$$Vd 1 = Vcc \times \frac{Rc + Rym}{RI + Rxp + Rc + Rym} \qquad ( 1 )$$

A first interrupt voltage Vd1 indicates the voltage measured by the detector 360. In Equation (1), in comparison with the comparison resistor R1 and a variable resistor Rc, the second resistor Rxp and the third resistor Rym have relatively small resistance values. For instance, in comparison with the comparison resistor R1 and the variable resistor Rc, the second resistor Rxp and the third resistor Rym have negligibly small resistance values. In this case, it may be understood that the first interrupt voltage Vd1 corresponds to a ratio of the variable resistor Rc to the comparison resistor R1 and the variable resistor Rc. For instance, the voltage measured by the detector 360 is expressed as Equation (2).

$$Vd 2 \approx Vcc \times \frac{Rc}{RI + Rc} \qquad ( 2 )$$

A second interrupt voltage Vd2 indicates the voltage measured by the detector 360 in the case that the second resistor Rxp and the third resistor Rym are negligible. The touch panel interface 120 compares the second interrupt voltage Vd2 with a reference voltage, e.g., Vcc/2. For example, when the second interrupt voltage Vd2 decreases and reaches the reference voltage, i.e., when a user touches the screen and applies pressure thererto, the touch panel interface 120 generates the down interrupt. In anther example, when the second interrupt voltage Vd2 increases and reaches the reference voltage, i.e., when a user releases the screen and pressure applied thereto, the touch panel interface 120 generates the up interrupt. From another aspect, if the value of the variable resistor Rc (refer to FIG. 3) decreases and reaches a preset resistance value (hereinafter, referred to as an interrupt resistance value), the down interrupt is generated. After the down interrupt, if the value of the variable resistor Rc increases and reaches the interrupt resistance value, the up interrupt is generated.

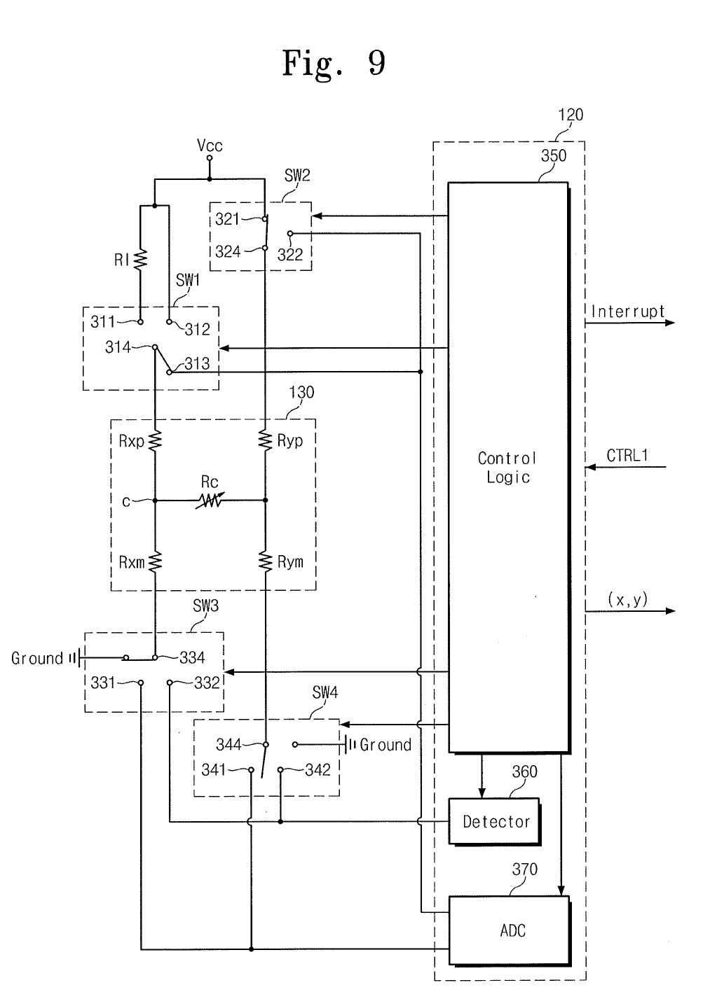

FIG. 8 illustrates a block diagram of a state of the touch panel interface 120 and the touch screen panel 130 when the x-coordinate is obtained. It is noted that the x-coordinate is obtained only if a down interrupt is detected in operation S120.

Referring to FIG. 8, the first switch SW1 connects the terminal 314 to the terminal 312, so the power supply voltage Vcc is provided to the touch screen panel 130. At the second switch SW2, the terminal 324 is not connected to any of the terminals 321 and 322, i.e., the terminal is at an open state. The third switch SW3 connects the terminal 334 to the ground terminal, so the ground voltage is applied to the terminal 334. The fourth switch SW4 connects the terminal 344 to the terminal 341, so the terminal of the touch screen panel 130 is connected to the AD converter 370.

It is assumed that the input impedance of the AD converter 370 is infinite. Accordingly, the power supply terminal, the second resistor Rxp, the first resistor Rxm and the ground terminal are connected in series. Accordingly, the voltage of the node, i.e., the touched point (c), between the first resistor Rxm and the second resistor Rxp is transferred to the AD converter 370. For instance, the voltage input to the AD converter 370 is expressed as Equation (3).

$$Vad 1 = Vcc \times \frac{Rxm}{Rxm + Rxp} \qquad ( 3 )$$

An x-coordinate voltage Vad1 indicates the coordinate information transferred to the AD converter 370. The x-coordinate voltage Vad1 indicates a ratio of the first resistor Rxm to the first and second resistors Rxm and Rxp. The resistance values of the first and second resistors Rxm and Rxp are varied according to a position of the touched point (c). That is, the x-coordinate voltage Vad1 includes the information about the x-coordinate of the touched point (c).

The AD converter (370) converts the x-coordinate voltage Vad1 to a digital logic value. For instance, the digital logic value may be expressed as 10-bit data. For instance, the digital logic value may be expressed as 12-bit data. The converted digital logic value may correspond to the x-coordinate of the touched point of the touch screen panel (130).

The touch panel interface 120 and the touch screen panel 130 may be configured for obtaining the y-coordinate in the same manner as obtaining the x-coordinate. At the first switch SW1, the terminal 314 is not connected to any of the terminals 311, 312 and 313, i.e., the terminal 314 is in the open state. At the second switch SW2, the terminal 324 is connected to the terminal 321, so the power supply voltage Vcc is applied to the terminal 324. At the third switch SW3, the terminal 334 is connected to the terminal 331, so the terminal 334 of the touch screen panel 130 is connected to the AD converter 370. At the fourth switch SW4, the terminal 344 is connected to the ground terminal, so the ground voltage is applied to the terminal 344.

In this case, the fourth resistor Ryp, the third Rym, and the ground terminal are connected in series. A voltage, which corresponds to a ratio of the third resistor Rym to the third resistor Rym and the fourth resistor Ryp, is input to the AD converter 370. For instance, the voltage input to the AD converter 370 is expressed as Equation (4).

$$Vad 2 = Vcc \times \frac{Rym}{Rym + Ryp} \qquad ( 4 )$$

A y-coordinate voltage Vad2 indicates the coordinate information transferred to the AD converter 370. The resistance values of the third and fourth resistors Rym and Ryp are changed according to the position of the touched point (c). That is, the y-coordinate voltage Vad2 includes the information about the y-coordinate of the touched point (c).

The y-coordinate voltage Vad2 is converted to a digital logic value. The converted digital logic value may correspond to the y-coordinate of the touched point of the touch screen panel (130).

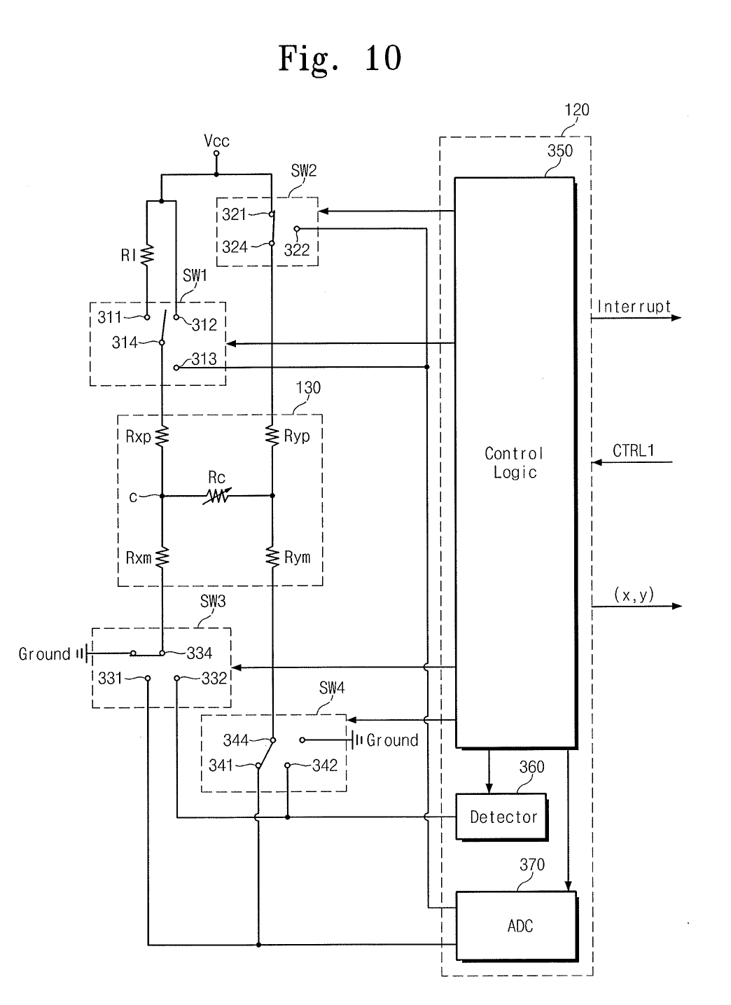

FIG. 9 illustrates a block diagram of a state of the touch panel interface 120 and the touch screen panel 130 when a value of first impedance Z1 is measured. The first impedance Z1 indicates a ratio of the first resistor Rxm to the fourth resistor Ryp, the variable resistor Rc, and the first resistor Rxm.

Referring to FIG. 9, the first to fourth switches SW1 to SW4 are operated in response to the control of the control logic 350. The first switch SW1 connects the terminal 314 to the terminal 313, so the terminal 314 is connected to the AD converter 370. At the second switch SW2, the terminal 324 is connected to the terminal 321, so the power supply voltage Vcc is provided to the terminal 324. At the third switch SW3, the terminal 334 is connected to the ground terminal, so the ground voltage is applied to the terminal 334. At the fourth switch, the terminal 344 is configured as the open state.

It is assumed that the input impedance of the AD converter 370 is infinite. Accordingly, the power supply terminal, the fourth resistor Ryp, the variable resistor Rc, the first resistor Rxm and the ground terminal are connected in series. A voltage, which corresponds to a ratio of the first resistor Rxm to the fourth resistor Ryp, the variable resistor Rc and the first resistor Rxm, is input to the AD converter 370. For instance, the voltage input to the AD converter 370 is expressed as Equation (5).

$$Vad 3 = Vcc \times \frac{Rxm}{Ryp + Rc + Rxm} \qquad ( 5 )$$

For instance, the AD converter 370 receives a first impedance voltage Vad3 calculated by Equation (5). The received first impedance voltage Vad3 is converted to a digital logic value by the AD converter 370. That is, the converted digital logic value corresponds to the first impedance Z1.

FIG. 10 illustrates a block diagram of a state of the touch panel interface 120 and the touch screen panel 130 when a value of second impedance Z2 is measured. The second impedance Z2 indicates a ratio of the variable resistor Rc and the first resistor Rxm to the fourth resistor Ryp, the variable resistor Rc and the first resistor Rxm.

Referring to FIG. 10, the terminal 314 of the first switch SW1 is configured as the open state. At the second switch SW2, the terminal 324 is connected to the terminal 321, so the power supply voltage Vcc is provided to the terminal 324. At the third switch SW3, the terminal 334 is connected to the ground terminal, so the ground voltage is applied to the terminal 334. At the fourth switch SW4, the terminal 344 is connected to the terminal 341, so the terminal 344 is connected to the AD converter 370.

It is assumed that the input impedance of the AD converter 370 is infinite. Herein, the power supply terminal, the fourth resistor Ryp, the variable resistor Rc, the first resistor Rxm and the ground are connected in series. A voltage, which corresponds to a ratio of the variable resistor Rc and the first resistor Rxm to the fourth resistor Ryp, the variable resistor Rc and the first resistor Rxm, is input to the AD converter 370. For instance, the voltage input to the AD converter 370 is expressed as Equation (6).

$$Vad 4 = Vcc \times \frac{Rc + Rxm}{Ryp + Rc + Rxm} \qquad ( 6 )$$

A second impedance voltage Vad4 calculated by Equation (6) is input to the AD converter 370. The AD converter 370 converts the input second impedance voltage Vad4 to a digital logic value. That is, the converted digital logic value corresponds to the second impedance Z2.

The x-coordinate, the y-coordinate, and the values corresponding to the first and second impedances Z1 and Z2, which have been explained referring to FIGS. 8 to 10, may be transferred to the touch driver 110 (refer to FIG. 1).

FIG. 11 illustrates a flow chart of a method for obtaining coordinates for the touch driver 110 according to the embodiment of the inventive concept. The coordinate obtainment method illustrated in FIG. 11 corresponds to the operations S130 to S150 of FIG. 5.

Referring to FIGS. 1 and 11, when the touch interrupt ITRT1 is generated and transmitted to the CPU 140 (FIG. 1), the CPU 140 may transfer the third control signal CTRL3 to the touch driver 110. In response to the third control signal CTRL3, the touch driver 110 may transfer the first control signal CTRL1 to the touch panel interface 120 (operation S210 in FIG. 11). In response to the first control signal CTRL1, the touch panel interface 120 measures the voltage which corresponds to the x-coordinate and y-coordinate and the voltages which correspond to the first and second impedances Z1 and Z2. The measured voltage which corresponds to the x-coordinate and y-coordinate and voltages which correspond to the first and second impedances Z1 and Z2 are respectively converted to the digital logic values by the AD converter 370 (refer to FIGS. 8 and 9). The converted digital logic values are transferred to the touch driver 110. That is, the touch driver 110 receives the digital logic values which correspond to the x and y-coordinates and the first and second impedances Z1 and Z2 (operation S220).

The touch driver 110 may calculate the resistance value of the variable resistor Rc (refer to FIGS. 6 to 10) by using the received digital logic values (operation S230). For instance, the resistance value of the variable resistor Rc may be calculated based on Equation (7) below.

$$Rc = \frac{{R}_{X \text{-} Plate} \times x coordinate}{α} \times ( \frac{α}{Z 1} - 1 ) - {R}_{Y \text{-} Plate} \times ( 1 - \frac{y coordinate}{α} ) \qquad ( 7 )$$

In Equation 7, a value of an x-axis resistor R_{X-Plate} is a sum of the second resistor Rxp and the first resistor Rxm of FIG. 6, and α is a constant. For instance, a should be considered according to the power supply voltage Vcc and the number of bits of the converted logic value.

For instance, it is assumed that α is 1. It is assumed that the digital logic value, which corresponds to the x-coordinate received by the touch driver 110, ranges from 0 to 1. That is, it is assumed that a sum of a length of the first resistor Rxm and a length of the second resistor Rxp corresponds to 1. It is assumed that the digital logic value, which corresponds to the y-coordinate received by the touch driver 110, ranges from 0 to 1. That is, it is assumed that a sum of a length of the third resistor Rym and a length of the fourth resistor Ryp corresponds to 1.

According to the above-mentioned assumptions, “x coordinate” received by the touch driver 110 may correspond to the length of the first resistor Rxm. Therefore, “R_{X-Plate}×x coordinate” in Equation 7 may correspond to the resistance value of the first resistor Rxm. The first impedance Z1 may be calculated by Equation (8).

$$Z 1 = \frac{Rxm}{Ryp + Rc + Rxm} \qquad ( 8 )$$

Referring to Equation (7) again, “y coordinate” received by the touch driver 110 may correspond to the length of the third resistor Rym. “1-y coordinate” may correspond to the length of the fourth resistor Ryp. Accordingly, R_{Y-Plate}×(1−y coordinate) may correspond to the value of the fourth resistor Ryp. Therefore, the resistance value of the variable resistor Rc may be calculated by Equation (9) based on Equations (7) and (8).

Rc=(Rc+Ryp)−Ryp (9)

In Equation (7), the second impedance Z2 is not used. That is, in Equation (7), the x and y-coordinates and the first impedance Z1 are used. Accordingly, in response to the first control signal, the voltage corresponding to the x and y-coordinates and the voltage corresponding to the first impedance Z1 may be measured at the touch panel interface 120. The measured voltages corresponding to the x and y-coordinates and the first impedance Z1 may be converted to the digital logic values by the AD converter 370 (refer to FIGS. 8 and 9) and transferred to the touch driver 110. Equation (7) is merely an example for calculating the variable resistor Rc. The variable resistor Rc may be also calculated in another manner.

For instance, the resistance value of the variable resistor Rc may be calculated based on Equation (10).

$$Rc = {R}_{X \text{-} Plate} \times \frac{X coordinate}{α} \times ( \frac{Z 2}{Z 1} - 1 ) \qquad ( 10 )$$

The value of the x-axis resistor R_{X-Plate} is the sum of the second resistor Rxp and the first resistor Rxm of FIG. 6. α is configured according to the power supply voltage Vcc and the number of bits of the converted logic values.

For instance, it is assumed that α is 1. It is assumed that the digital logic value, which corresponds to the x-coordinate received by the touch driver 110, ranges from 0 to 1. That is, it is assumed that the sum of the length of the first resistor Rxm and the length of the second resistor Rxp corresponds to 1. It is assumed that the digital logic value, which corresponds to the y-coordinate received by the touch driver 110, ranges from 0 to 1. That is, it is assumed that the sum of the length of the third resistor Rym and the length of the fourth resistor Ryp corresponds to 1.

As above-described referring to Equation (7), “x coordinate” received by the touch driver 110 may correspond to the length of the first resistor Rxm. Therefore, “R_{X-Plate}×x coordinate” may correspond to the resistance value of the first resistor Rxm. The first impedance Z1 may be calculated by Equation (8). The second impedance Z2 may be calculated by Equation (11).

$$Z 2 = \frac{Rxm + Rc}{Ryp + Rc + Rxm} \qquad ( 11 )$$

Accordingly, the resistance value of the variable resistor Rc may be calculated by Equation (12) based on Equations (10) and (11).

$$Rc = Rxm \times ( \frac{Rxm + Rc}{Rxm} - 1 ) \qquad ( 12 )$$

In operation 5240, the touch driver 110 compares the variable resistor Rc calculated in operation 5230 with the first critical resistance value CRV1. The first critical resistance value CRV1 may be differently configured according to a kind of the touch panel screen 130. The first critical resistance value CRV1 may be smaller than the interrupt resistance value.

In the case that the calculated value of the variable resistor Rc is larger than the first critical resistance value CRV1, the touch driver 110 determines that the digital logic values, which correspond to the received x and y-coordinates, are invalid and transfers the invalidation signal to the CPU 140 (operation S260).

In the case that the calculated value of the variable resistor Rc is smaller than the first critical resistance value CRV1, the touch driver 110 determines that the digital logic values, which correspond to the received x and y-coordinates, are valid, and transfers the digital logic values, which correspond to the received x and y-coordinates, to the CPU 140 (operation S250).

That is, in the case that the calculated value of the variable resistor Rc is smaller than the first critical resistance value CRV1, the touch screen system 100 confirms the digital logic values which correspond to the obtained x and y-coordinates, i.e., determines that the obtained x and y-coordinates are valid. The touch screen system 100 disregards, i.e., invalidates, the digital logic values which correspond to the obtained x and y-coordinates in the case that the calculated value of the variable resistor Rc is larger than the first critical resistance value CRV1.

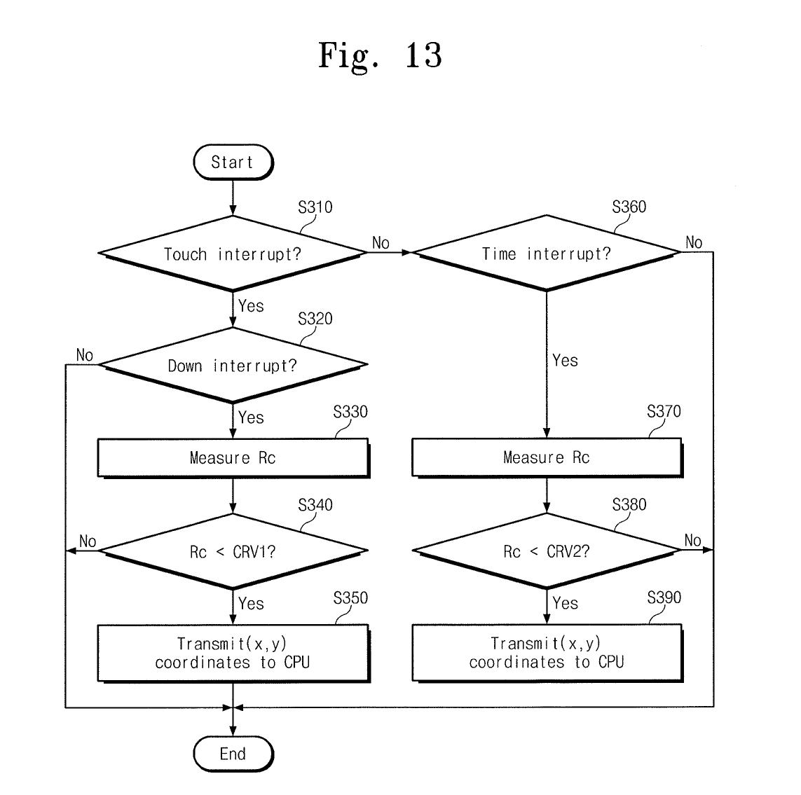

FIG. 12 illustrates a block diagram of a touch screen system 400 according to a second embodiment of the inventive concept. Referring to FIG. 12, the touch screen system 400 may include a touch driver 410, a touch panel interface 420, a touch screen panel 430, a CPU 440, and a timer 450.

The touch driver 410 may be connected to the touch panel interface 420 and the CPU 440. The touch driver 410 may be operated in response to control of the CPU 440. According to the control of the CPU 440, the touch driver 410 may transfer a first control signal CTRL1 or a second control signal CTRL2 to the touch panel interface 420. The touch driver 410 may be the software or firmware driven at the touch panel interface 420 or the CPU 440.

The touch panel interface 420 may be connected to the touch driver 410, the touch screen panel 430, the CPU 440, and the timer 450. As above-described in FIGS. 1 to 11, in the case that the touch screen panel 430 is touched, the down interrupt or the up interrupt is generated. The down interrupt and the up interrupt are included in the touch interrupt ITRT1. The down interrupt or the up interrupt generated at the touch panel interface 420 is transferred to the CPU 440.

In response to the first control signal CTRL1 or the second control signal CTRL2 received from the touch driver 410, the voltages which correspond to the x and y-coordinates of the touched point and the first and second impedances Z1 and Z2 may be measured at the touch panel interface 420 (as explained referring to FIGS. 8 to 10).

The measured voltages which correspond to the x and y-coordinates and the first and second impedances Z1 and Z2 are converted to the digital logic values and transferred to the touch driver 410. The touch driver 410 calculates the value of the variable resistor Rc by using the received digital logic values which correspond to the x and y-coordinates and the first and second impedances Z1 and Z2.

In the case that the first control signal CTRL1 is transferred to the touch panel interface 420 from the touch driver 410, the calculated value of the variable resistor Rc is compared with the first critical resistance value CRV1. The first critical resistance value CRV1 may be differently configured according to the kind of the touch screen panel 430. The first critical resistance value CRV1 may be smaller than the interrupt resistance value.

In the case that the value of the variable resistor Rc is smaller than the first critical resistance value CRV1, the touch driver 410 treats the digital logic values which corresponds to the received x and y-coordinates as valid. And, the touch driver 410 transfers the digital logic values which correspond to the received x and y-coordinates to the CPU 440.

In the case that the value of the variable resistor Rc is larger than the first critical resistance value CRV1, the touch driver 410 treats the digital logic values which corresponds to the received x and y-coordinates as invalid. That is, the touch driver 410 transfers the invalidation signal to the CPU 440. In other words, the information of the x and y-coordinates are transferred to the CPU 440 only when the value of the variable resistor Rc is smaller than the first critical resistance value CRV1.

In the case that the second control signal CTRL2 is transferred to the touch panel interface 420 from the touch driver 410, the calculated value of the variable resistor Rc is compared with a second critical resistance value CRV2. The second critical resistance value CRV2 may be differently configured according to the kind of the touch screen panel. The second critical resistance value CRV2 may be smaller than the interrupt resistance value. The second critical resistance value CRV2 may be larger than or equal to the first critical resistance value CRV1.

In the case that the value of the variable resistor Rc is smaller than the second critical resistance value CRV2, the touch driver 410 transfers the digital logic values, which correspond to the x and y-coordinates received from the touch panel interface 420, to the CPU 440.

In the case that the value of the variable resistor Rc is larger than the second critical resistance value CRV2, the touch driver 410 treats the digital logic values, which correspond to the x and y-coordinates received from the touch panel interface 420, as invalid. And, the touch driver 410 transfers the invalidation signal to the CPU 440. That is, in the case that the invalidation signal is transferred to the CPU 440, the x and y-coordinates are not obtained by the CPU 440.

The CPU 440 receives the touch interrupt ITRT1 from the touch panel interface 420. The CPU 440 receives a time interrupt ITRT2 from the timer 450.

When the up interrupt (not shown) among the touch interrupt ITRT1 is received, the CPU 440 controls the touch screen system 400 not to obtain the coordinate information. That is, in the case that the user completes the input of the coordinate to the touch screen panel 130, the coordinate is not obtained. For instance, the CPU 440 which has received the up interrupt (not shown) transfers a standby control signal (not shown) to the touch driver 410. And, the touch driver 410 which has received the standby control signal controls the touch panel interface 420 for the touch panel interface 420 to operate in a standby state for monitoring the resistance value of the variable resistor Rc of the touch screen panel 430.

When the down interrupt (not shown) among the touch interrupt ITRT1 is received by the CPU 440, the CPU 440 transfers the third control signal CTRL3 to the touch driver 410 for obtaining the coordinate information of the touched point. The touch driver 410 which has received the third control signal CTRL3 transfers the first control signal CTRL1 to the touch panel interface 420.

When the time interrupt ITRT2 is received by the CPU 440, the CPU 440 transfers a fourth control signal CTRL4 to the touch driver 410 for obtaining the coordinate information of the touched point. The touch driver 410 which has received the fourth control signal CTRL4 transfers the second control signal CTRL2 to the touch panel interface 420.

The timer 450 receives the touch interrupt ITRT1 from the touch panel interface 420. When the timer 450 receives the down interrupt, the timer 450 may generate the time interrupt ITRT2 at regular intervals.

The time interrupt ITRT2 may be generated at regular time intervals at the timer 450 from when the timer 450 receives the down interrupt to when the timer 450 receives the up interrupt. For instance, the time interrupt ITRT2 may be generated while the user performs a drag operation to the touch screen panel 430. The time interrupt ITRT2 generated at the timer 450 is transferred to the CPU 440.

Although not illustrated in FIG. 12, the timer 450 may receive a timer driving signal (not shown) from the touch driver 410 instead of receiving the touch interrupt ITRT1 from the touch panel interface 420. The timer driving signal is generated at the touch driver 410 when the resistance value of the variable resistor Rc calculated in response to the third control signal CTRL3 of the CPU 440 is smaller than the first critical resistance value CRV1. The timer 450 may receive a timer driving stop signal (not shown) from the touch driver 410. The timer driving stop signal is generated by the touch driver 410 in response to the standby control signal (not shown) transferred from the CPU 440 which has received the up interrupt to the touch driver 410. The timer 450 generates the time interrupt ITRT2 at regular time interval from when the timer driving signal is received to when the timer driving stop signal is received.

The touch driver 410, the touch panel interface 420, the CPU 440, and the timer 450 may be included in a touch panel controller 460.

FIG. 13 illustrates a flow chart of the coordinate obtainment method of the touch screen system 400.

Referring to FIGS. 12 and 13, in operation S310, the CPU 440 determines whether the received interrupt is the touch interrupt ITRT1 or the time interrupt ITRT2. In the case that the received interrupt is the touch interrupt ITRT1, it is determined whether the touch interrupt ITRT1 is the down interrupt (operation S320). In the case that the received interrupt is not the touch interrupt ITRT1, operation S360 is performed.

In the case that the touch interrupt ITRT1 is the up interrupt, the CPU 440 finishes the obtainment of the x and y-coordinates. In the case that the received touch interrupt ITRT1 is the down interrupt, operation S330 is performed.

In operation 5330, the touch driver 410 measures the variable resistor Rc (refer to FIGS. 8 to 10). In response to the third control signal CTRL3 received from the CPU 440, the touch driver 410 transfers the first control signal CTRL1 to the touch panel interface 420. In response to the first control signal CTRL1 received from the touch driver 410, the touch panel interface 420 measures the voltages which correspond to the x and y-coordinates and the first and second impedances Z1 and Z2 (refer to FIGS. 8 to 10). The measured voltages which correspond to the x and y-coordinates and the first and second impedances Z1 and Z2 are converted to the digital logic values by the AD converter 370. The converted digital logic values are transferred to the touch driver 410.

The touch driver 410 calculates the value of the variable resistor Rc by using the digital logic values received from the touch panel interface 420. For instance, the value of the variable resistor Rc is calculated according to Equations (7) or (10).

In operation 5340, the touch driver 410 compares the calculated value of the variable resistor Rc with the first critical resistance value CRV1. In the case that the calculated value of the variable resistor Rc is larger than the first critical resistance value CRV1, the touch driver 410 invalidates the digital logic values which correspond to the x and y-coordinates, and transfers the invalidation signal to the CPU 440.

In the case that the calculated value of the variable resistor Rc is smaller than the first critical resistance value CRV1, the touch driver 410 transfers the digital logic values which correspond to the x and y-coordinate to the CPU 440 (S350). That is, in the case that the value of the variable resistor Rc is smaller than the first critical resistance value CRV1, the information of the x and y-coordinates is transferred to the CPU 440.

Referring to operation S310 again, the CPU 440 determines whether the received interrupt is the touch interrupt ITRT1 or the time interrupt ITRT2. In the case that the received interrupt is not the touch interrupt ITRT1, the CPU 440 determines whether the received interrupt is the time interrupt ITRT2 (S360). In the case that the received interrupt is not the time interrupt ITRT2 (for instance, in the case that it cannot be determined whether the interrupt is the touch interrupt ITRT1 or the time interrupt ITRT2 due to distortion of the received signal), the CPU 440 disregards the received interrupt. That is, the x and y-coordinates are not obtained. In the case that the received interrupt is the time interrupt ITRT2, operation 5370 is performed.

In operation S370, the touch driver 410 measures the variable resistor Rc. The touch driver 410 transfers the second control signal CTRL2 to the touch panel interface 420 in response to the fourth control signal CTRL4 received from the CPU 440. In response to the second control signal CTRL2, the touch panel interface 420 measures the voltages which correspond to the x and y-coordinates and the first and second impedances Z1 and Z2 (refer to FIGS. 8 to 10). The measured voltages which correspond to the x and y-coordinates and the first and second impedances Z1 and Z2 are converted to the digital logic values by the AD converter 370. The converted digital logic values are transferred to the touch driver 410. The touch driver 410 calculates the variable resistor Rc by using the received digital logic values.

In operation S380, the touch driver 410 compares the calculated value of the variable resistor Rc with the second critical resistance value CRV2. The second critical resistance value CRV2 may be differently configured according to the kind of the touch screen panel. The second critical resistance value CRV2 may be smaller than the interrupt resistance value. The second critical resistance value CRV2 may be larger than or equal to the first critical resistance value CRV1. The second critical resistance value CRV2 may be smaller than the interrupt resistance value and larger than or equal to the first critical resistance value CRV1.

In the case that the value of the variable resistor Rc is smaller than the second critical resistance value CRV2, the touch driver 410 transfers the received digital logic values, which correspond to the x and y-coordinates, to the CPU 440 (S390). The CPU 440 may control the touch screen system 400 by using the received information of the x and y-coordinates. For instance, the CPU 440 may transfer the received x and y-coordinates information to the display driver (not shown) and control the display driver to display the x and y-coordinates of the touched point on the touch screen panel 410.

In the case that the value of the variable resistor Rc is larger than the second critical resistance value CRV2, the touch driver 410 invalidates the digital logic values which correspond to the received x and y-coordinates, and transfers the invalidation signal to the CPU 440. That is, in the case that the value of the variable resistor Rc is smaller than the second critical resistance value CRV2, the CPU 440 receives the information of the x and y-coordinates.

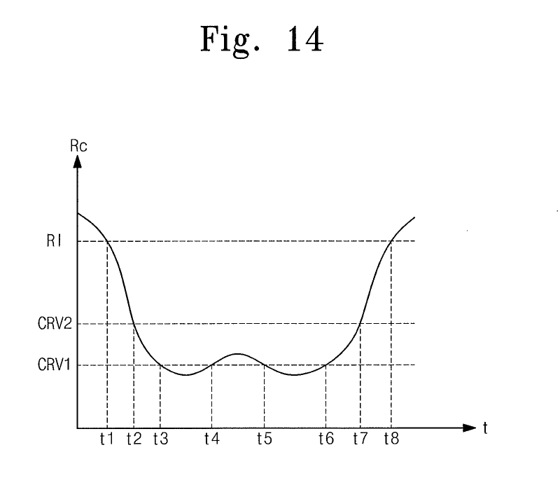

FIG. 14 illustrates a graph of the value of the variable resistor Rc which changes according to time. In FIG. 14, the horizontal axis represents the time. The vertical axis represents the value of the variable resistor Rc.

Referring to FIG. 14, at a first time t1, since the value of the variable resistor Rc decreases and reaches the interrupt resistance RI, the down interrupt is generated. At an eighth time t8, since the value of the variable resistor Rc increases and reaches the interrupt resistance RI, the up interrupt is generated.

The first critical resistance value CRV1 is the maximum value of the variable resistor Rc for obtaining the x and y-coordinates information when the touch interrupt ITRT1 is generated. The second critical resistance value CRV2 is the maximum value of the variable resistor Rc for obtaining the x and y-coordinates information when the time interrupt ITRT2 is generated. In FIG. 14, it is illustrated that the second critical resistance value CRV2 is larger than the first critical resistance value CRV1.

At the first time t1, the down interrupt is generated.

For instance, it is assumed that the point of time when the voltages which correspond to the x and y-coordinates and the first and second impedances Z1 and Z2 are measured at the touch panel interface 420 (refer to FIG. 12) in response to the down interrupt is between the first time t1 and a third time t3. The variable resistor Rc is calculated based on the voltages which correspond to the x and y-coordinates and the first and second impedances Z1 and Z2 and has been measured at the touch panel interface 420.

At this time, the value of the variable resistor Rc calculated at the touch driver 410 (refer to FIG. 12) is larger than the first critical resistance value CRV1. Therefore, the touch driver 410 ignores the obtained information of the x and y-coordinates. That is, in the case that pressure is unintentionally applied to the touch screen panel 430 (refer to FIG. 12) by the user, the x and y-coordinates information of the touched point may not be obtained by using the first critical resistance value CRV1.

For another example, it is assumed that the point of time when the voltages which correspond to the x and y-coordinates and the first and second impedances Z1 and Z2 are measured at the touch panel interface 420 in response to the down interrupt is between the third time t3 and a fourth time t4. In this case, since the value of the variable resistor Rc calculated at the touch driver 410 is smaller than the first critical resistance value CRV1, the touch screen panel 400 obtains the x and y-coordinates information.

The timer 450 generates the time interrupt ITRT2 at a regular time interval based on the first time t1 at which the down interrupt is generated. For instance, after preset time is elapsed from the generation of the down interrupt, the time interrupt ITRT2 is periodically generated.

For another example, in the case that the variable resistor Rc calculated at the touch driver 410 is smaller than the first critical resistance value CRV1, the timer 450 may receive the timer driving signal generated at the touch driver 410 and generate the time interrupt ITRT2 in response to the timer driving signal. In the case that the time interrupt ITRT2 is generated at the timer 450 in response to the timer driving signal, the time interrupt ITRT2 is generated at least after the third time t3 at the timer 450.

It is assumed that the point of time when the voltages which correspond to the x and y-coordinates and the first and second impedances Z1 and Z2 are measured at the touch panel interface 420 according to the first generation of the time interrupt ITRT2 is between the fourth time t4 and a fifth time t5. At this time, the value of the variable resistor Rc calculated at the touch driver 410 is smaller than the second critical resistance value CRV2. Therefore, the x and y-coordinates information is transferred to the CPU 440 from the touch driver 410. In the case that the user maintains the touch state, even in the case that the variable resistor Rc is larger than the first critical resistance value CRV1, the touch screen system 400 may obtain the coordinates if the variable resistor Rc is smaller than the second critical resistance value CRV2. That is, even in the case that the pressure applied to the touch screen panel 430 by the user is changed, the touch screen system 400 recognizes this case as the touch state and performs the coordinate obtainment operation.

Also in the case that the point of time when the voltages which correspond to the x and y-coordinates and the first and second impedances Z1 and Z2 are measured according to the second generation of the time interrupt ITRT2 is between the fifth time t5 and a seventh time t7, the touch screen system 400 obtains the x and y-coordinates in the same manner.

It is assumed that the point of time when the voltages which correspond to the x and y-coordinates and the first and second impedances Z1 and Z2 are measured according to the third generation of the time interrupt ITRT2 is between the seventh time t7 and the eighth time t8. The value of the variable resistor Rc calculated at the touch driver 410 is larger than the second critical resistance value CRV2. Therefore, the touch screen system 400 cannot obtain the x and y-coordinates information.

If the up interrupt is generated at the eighth time t8, the timer 450 stops generating the time interrupt in response to the up interrupt.

As above-described, according to the embodiment of the inventive concept, if pressure, which is smaller than corresponding pressure of the first critical resistance value CRV1, is applied to the touch screen panel 130 or 430, the obtained coordinate information is ignored. Accordingly, the touch screen system 100 or 400 may be prevented from abnormal operation due to unintentional touch.

Also, according to the embodiment of the inventive concept, if pressure, which is larger than corresponding pressure of the second critical resistance value CRV2, is applied to the touch screen panel 430 after the time interrupt ITRT2 is generated, the obtained coordinate information is confirmed. Therefore, even in the case that the pressure applied to the touch screen panel 430 is varied due to user's carelessness, the touch screen system 400 can be normally operated.

According to the embodiment of the inventive concept, it is additionally determined whether to obtain the coordinate information based on the resistance value of the touch screen panel when the touch interrupt is generated. Therefore, the touch screen system with improved reliability is provided.

The above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method for obtaining a coordinate of a touch screen system, the method comprising:
generating an interrupt according to a change in a resistance value between an upper resistance layer and a lower resistance layer of a touch screen panel;
obtaining coordinate information of a point corresponding to the changed resistance value between the upper and lower resistance layers, the coordinate information being obtained in response to the interrupt;
determining the changed resistance value by using the obtained coordinate information; and
determining validity of the obtained coordinate information according to the determined changed resistance value.

2. The method as claimed in claim 1, wherein generating the interrupt includes generating an interrupt according to a change in a lowest resistance value between the upper resistance layer and the lower resistance layer.

3. The method as claimed in claim 1, wherein generating the interrupt includes generating a down interrupt when the resistance value between the upper resistance layer and the lower resistance layer decreases and reaches an interrupt resistance value.

4. The method as claimed in claim 3, wherein determining validity of the obtained coordinate information includes validating the obtained coordinate information when the determined resistance value is smaller than a first critical resistance value.

5. The method as claimed in claim 4, wherein the first critical resistance value is smaller than the interrupt resistance value.

6. The method as claimed in claim 3, further comprising:
generating a time interrupt when the determined resistance value is smaller than a first critical resistance value;
obtaining coordinate information of a point corresponding to the changed resistance value between the upper resistance layer and the lower resistance layer in response to the time interrupt;
determining the changed resistance value by using the obtained coordinate information; and
determining validity of the obtained coordinate information according to the determined resistance value.

7. The method as claimed in claim 3, further comprising:
generating a time interrupt in response to the down interrupt;
obtaining coordinate information of a point corresponding to the changed resistance value between the upper resistance layer and the lower resistance layer in response to the time interrupt;
determining the changed resistance value by using the obtained coordinate information; and
determining validity of the obtained coordinate information according to the determined resistance value.

8. The method as claimed in claim 7, wherein generating the time interrupt includes periodically generating the time interrupt in response to the down interrupt.

9. The method as claimed in claim 8, wherein generating the time interrupt is stopped when a lowest resistance value between the upper and lower resistance layers increases and reaches a predetermined interrupt resistance value.

10. The method as claimed in claim 7, wherein:
the obtained coordinate information is confirmed when the detected resistance value is smaller than a first critical resistance value in the case that the down interrupt is generated, and
the obtained coordinate information is confirmed when the detected resistance value is smaller than a second critical resistance value in the case that the time interrupt is generated.

11. The method as claimed in claim 10, wherein the first and second critical resistance values are smaller than the interrupt resistance value.

12. The method as claimed in claim 10, wherein the second critical resistance value is larger than or equal to the first critical resistance value.

13. A method for obtaining a coordinate of a touch screen system, the method comprising:
determining a change of pressure applied to a touch screen panel;
obtaining coordinate information of a point on the touch screen panel corresponding to the changed pressure;
determining validity of the obtained coordinate information by comparing a changed resistance value on the touch screen panel with a predetermined reference value, the changed resistance value being calculated in accordance with the applied pressure and location of the point on the touch screen panel.

14. A touch screen system, comprising:
a touch screen panel including an upper resistance layer, a lower resistance layer, and an insulation layer between the upper resistance layer and the lower resistance layer, the insulation layer having a variable resistance value varying according to a distance between the upper resistance layer and the lower resistance layer; and
a touch panel controller configured to generate an interrupt according to the variable resistance value, to obtain coordinate information of a point corresponding to the variable resistance value in response to the interrupt, to detect the variable resistance value by using the obtained coordinate information, and to confirm the obtained coordinate information in the case that the detected resistance value is smaller than a first critical resistance value.

15. The touch screen system as claimed in claim 14, wherein the touch panel controller includes:
a central processing unit configured to activate a first control signal in response to a generated interrupt;
a touch driver configured to activate a second control signal in response to the activated first control signal; and
a touch panel interface configured to generate the interrupt according to the variable resistance value, and to obtain the coordinate information of a point corresponding to the variable resistance value in response to the activated second control signal,
wherein the touch driver detects the variable resistance value by using the obtained coordinate information, confirms the obtained coordinate information in the case that the detected resistance value is smaller than the first critical resistance value, and transfers the obtained coordinate information to the central processing unit.

16. The touch screen system as claimed in claim 15, wherein the touch panel controller further comprises a timer configured to generate a time interrupt, and the touch driver activates the timer in the case that the detected resistance value is smaller than the first critical resistance value.

17. The touch screen system as claimed in claim 15, wherein the touch panel interface generates a down interrupt when the variable resistance value decreases and reaches an interrupt resistance value.

18. The touch screen system as claimed in claim 17, wherein the touch panel controller further comprises a timer configured to generate a time interrupt in response to the down interrupt.

19. The touch screen system as claimed in claim 18, wherein the touch panel controller obtains the coordinate information of the point which corresponds to the variable resistance value in response to the time interrupt, detects the variable resistance value by using the obtained coordinate information, and confirms the obtained coordinate information in the case that the detected resistance value is smaller than a second critical resistance value.

20. The touch screen system as claimed in claim 19, wherein
the central processing unit activates a third control signal in response to the time interrupt;
the touch driver activates a fourth control signal in response to the activated third control signal;
the touch panel interface obtains the coordinate information of the point which corresponds to the variable resistance value in response to the activated fourth control signal; and
the touch driver detects the variable resistance value by using the obtained coordinate information, confirms the obtained coordinate information in the case that the detected resistance value is smaller than a second critical resistance value, and transfers the obtained coordinate information to the central processing unit.
